(19) United States
(12) Patent Application Publication
(10) Pub. No.: US 2015/0269903 A1
(43) Pub. Date: Sep. 24, 2015

(54) SIGNAL TRANSMISSION CIRCUIT

(71) Applicants: GLOBAL UNICHIP CORPORATION, Hsinchu City (TW); TAIWAN SEMICONDUCTOR MANUFACTURING CO., LTD., Hsin-chu (TW)

(72) Inventors: Wen-Tai Wang, Hsinchu County (TW); Sheng-Tsai Huang, Hsinchu County (TW); Yen-Cheng Chen, Taipei City (TW)

(21) Appl. No.: 14/662,726

(22) Filed: Mar. 19, 2015

(30) Foreign Application Priority Data
Mar. 19, 2014 (TW) 103110235

(51) Int. Cl. G09G 5/00; G09G 5/18

(52) U.S. Cl. CPC G09G 5/00; G09G 5/18; G09G 2300/04

(57) ABSTRACT

A signal transmission circuit is provided. The signal transmission circuit includes a first driving circuit including a first differential output pair, a plurality of input/output units and a calibration module. The first differential output pair includes a positive and a negative ends. The plurality of input/output units receive a positive and a negative control signals and generate a first superimposed current at the first differential output pair. The calibration module transmits a calibration signal to the first driving circuit. The calibration module sets operation of each of the input/output unit in the first driving circuit, and generates the first superimposed current flowing to a first external resistor according to the positive and the negative control signals.

This application claims the benefit of Taiwan application Serial No. 103110235, filed Mar. 19, 2014, the disclosure of which is incorporated by reference herein in its entirety.

### BACKGROUND

1. Technical Field

The disclosure relates in general to a signal transmission circuit and more particularly to a signal transmission circuit applied to a display system.

2. Description of the Related Art

With dramatically increase of multimedia data and rapid growth of network technology, high transmission interfaces are used in many communication products and consumer products for transmitting large volumes of data.

FIG. 1 is a schematic diagram illustrating a display system. In the display system, a host 11 such as a DVD player or a computer will transmit image data to a display control circuit 13 through an external control interface.

The external control interface may be a digital visual interface (hereinafter, DVI), a DisplayPort, a High-Definition Multimedia Interface (hereinafter, HDMI), Digital Interactive Interface for Video and Audio (hereinafter, DIIVA) and the like.

According to FIG. 1, the display control circuit 13 includes a main control chip 131, a frame rate/3D control circuit 133, and a timing controller 135.

For adjusting transmission of signal and image data, self defined internal control interfaces may be adopted between the main control chip 131 and the frame rate/3D control circuit 133, and between the frame rate/3D control circuit 133 and the timing controller 135.

Later, according to specification of a display 15, the timing controller 135 will output image signals of an image picture to the display 15 through a display control interface. Furthermore, a display control circuit 151 of the display 15 receives the image signals from the timing controller 135, and drives a display panel 153 to display the image picture.

The image signals include a gate driving signal for a gate driver, a source signal for a source driver, and various synchronous signals of the display panel 153. The synchronous signals include a horizontal synchronous signal (Hsync) and a vertical synchronous signal (Vsync).

Moreover, the timing controller 135 further includes multiple driving circuits wherein each of the driving circuit includes a differential pair circuit. A display control interface is consequentially formed by multiple differential pair circuits for transmitting the image signals.

Accordingly, having advantages such as high performance of transmission and high-level noise tolerance and the like, high speed differential pair circuits are widely utilized to implement high speed transmission interface. A driving circuit of a low-voltage differential signal (hereinafter, LVDS) is illustrated as an example.

FIG. 2 is a schematic diagram illustrating a conventional LVDS driving circuit. Basically, a differential output pair (TXP and TXN) of the LVDS driving circuit 21 is connected to the display 15. In the display 15, an external resistor (Rext) of a receiving end of the display control circuit 151 is connected to the differential output pair (TXP and TXN).

According to definition of the LVDS specification, the external resistor (Rext) of the display control circuit 151 is 100 ohm. Through the differential output pair (TXP and TXN), the LVDS driving circuit generates a voltage difference of +300 mV or 300 mV at two ends of the external resistor (Rext) to represent two logical levels.

Therefore, an equivalent current source 211, for generating a current switching between +3 mA and −3 mA, is provided by the LVDS driving circuit.

Outputted from the current source 211, the +3 mA current sequentially flows through a positive end of the differential output pair (TXP), the external resistor (Rext) and a negative end of the differential output pair (TXN). Accordingly, the voltage difference of +300 mV is generated at two ends of the external resistor (Rext). Alternately, outputted from the current source, the −3 mA current sequentially flows through the negative end of the differential output pair (TXN), the external resistor (Rext) and the positive end of the differential output pair (TXP). Accordingly, the voltage difference of −300 mV is generated at two ends of the external resistor (Rext).

### SUMMARY

The disclosure is directed to a signal transmission circuit utilizing blanking intervals to calibrate differential input/output units.

According to one embodiment, a signal transmission circuit is provided. The signal transmission circuit includes a first driving circuit including a first differential output pair, a plurality of input/output units and a calibration module. The first differential output pair, electrically connected to a first external resistor, includes a positive and a negative ends. The plurality of input/output units receive a positive and a negative control signals and generate a first superimposed current at the first differential output pair. The calibration module transmits a calibration signal to the first driving circuit. The calibration module determines whether the input/output units in the first driving circuit are in operation or not, and generates the first superimposed current flowing to the first external resistor according to the positive and the negative control signals.

### BRIEF DESCRIPTION OF THE DRAWINGS

FIG. 1 (prior art) is a schematic diagram illustrating a display system;

FIG. 2 (prior art) is a schematic diagram illustrating a conventional LVDS driving circuit;

FIG. 3 is a schematic diagram illustrating a differential pair in an LVDS driving circuit according to the present invention;

FIG. 4 is a schematic diagram illustrating a differential pair circuit in the driving circuit according to the present invention;

FIG. 5A is a schematic diagram illustrating an equivalent circuit of the first IO unit U1 when the positive control signal D+ is greater than the negative control signal D−;

FIG. 5B is a schematic diagram illustrating an equivalent circuit of the first IO unit U1 when the positive control signal D+ is less than the negative control signal D−;

FIG. 6 is a schematic diagram illustrating the calibration signal is utilized by the calibration module to adjust IO unit in the driving circuit; and

FIG. 7 is a schematic diagram illustrating multiple driving circuits output to the display control circuit.

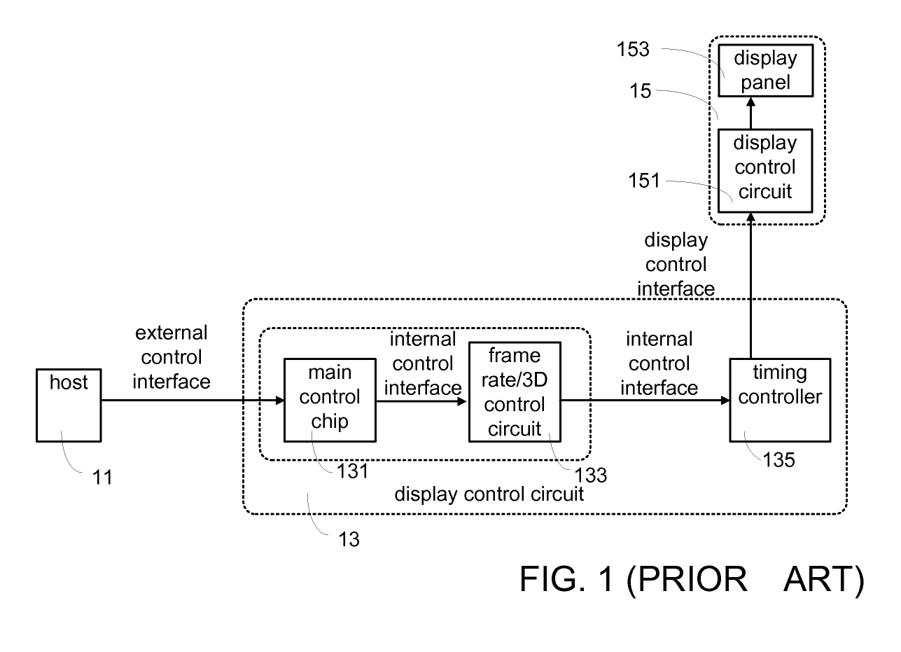

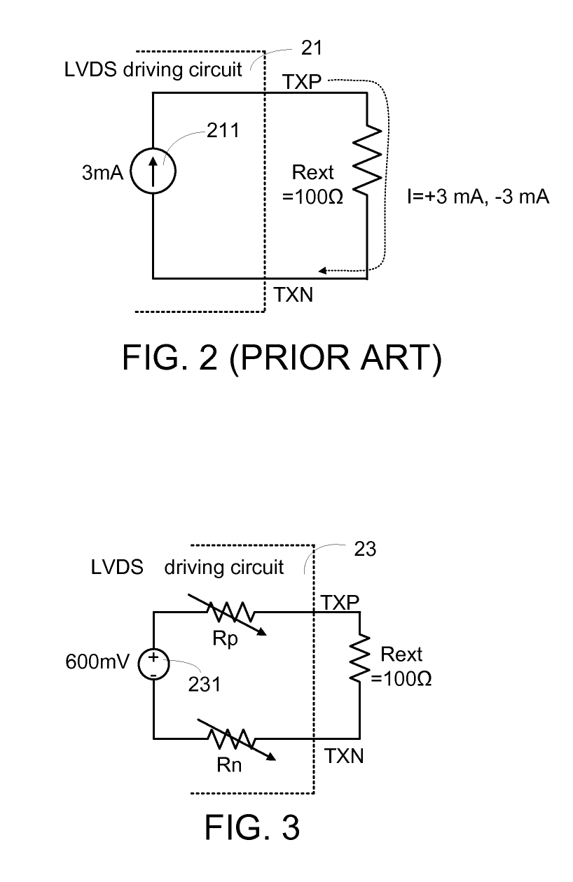

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

FIG. 3 is a schematic diagram illustrating a differential pair in an LVDS driving circuit according to the present invention. As mentioned above, the receiving end of the display control circuit includes the external resistor (Rext) with 100 ohm. The external resistor is electrically connected to the differential output pair (TXP and TXN). For generating two logical levels respectively with +300 mV or −300 mV at the two ends of the external resistor, an equivalent voltage source 231 of 600 mV, a positive resistor (Rp) at the positive end of the differential output pair (TXP) and a negative resistor (Rn) at the negative end of the differential output pair (TXN) are provided in the present invention. With polarity switching of the voltage source 231, the current flowing through the external resistor (Rext) is either +3 mA or −3 mA. Consequentially, a voltage difference of +300 mV or a −300 mV is generated at the two ends of the external resistor (Rext).

According to an embodiment of the present invention, resistance of both the positive resistor (Rp) and the negative resistor (Rn) are adjustable. When the positive resistor (Rp) and the negative resistor (Rn) are adjusted to 50 ohm, a voltage difference of +300 mV or −300 mV crossed at the two ends of the external resistor (Rext) will be generated by voltage dividing.

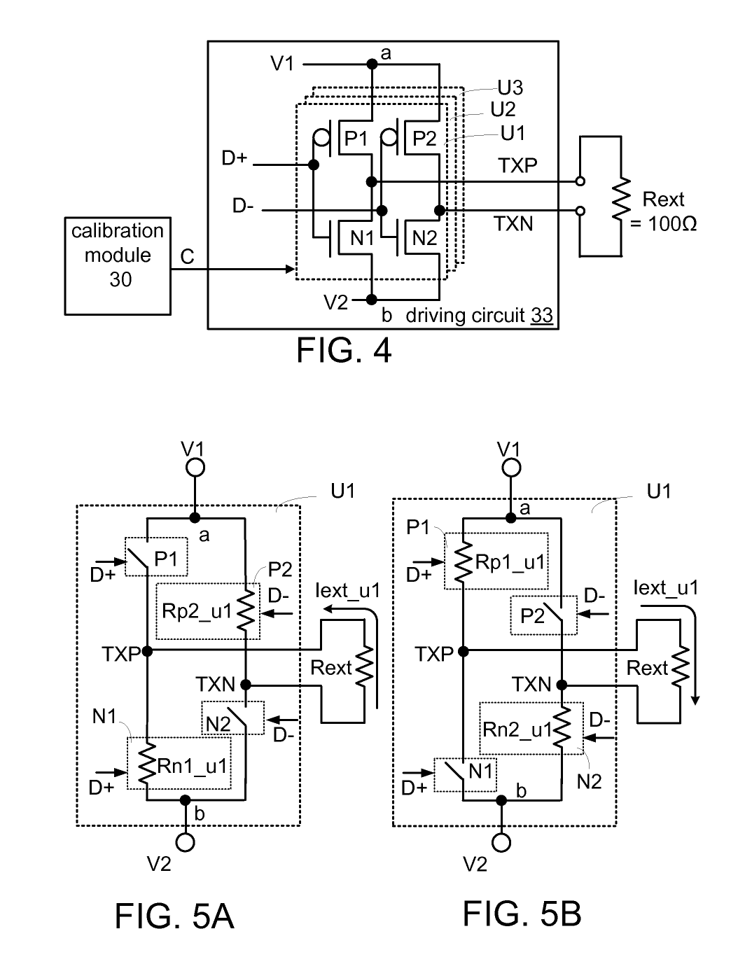

FIG. 4 is a schematic diagram illustrating a differential pair circuit in the driving circuit according to the present invention. The differential output pair (TXP and TXN) is connected to the external resistance (Rext). The differential pair circuit includes plural input/output units (IO units) U1, U2, U3 whose structures are similar and connected in parallel. A node “a” is connected to a first voltage V1, and a node “b” is connected to a second voltage (V2). A first IO unit U1 including a first P type transistor (P1), a first N type transistor (N1), a second P type transistor (P2) and a second N type transistor (N2) is illustrated as an example. A gate of the first P type transistor (P1) receives a positive control signal D+, a source of P1 is connected to the node “a”, and a drain of P1 is connected to the positive end of the differential output pair (TXP). A gate of the second P type transistor (P2) receives the negative control signal D−, a source of P2 is connected to the node “a”, and a drain of P2 is connected to the negative end of the differential output pair (TXN). A gate of the first N type transistor (N1) receives the positive control signal D+, a source of N1 is connected to the node “b”, and a drain of N1 is connected to the positive end of the differential output pair (TXP). A gate of the second N type transistor (N2) receives the negative control signal D−, a source of N2 is connected to the node “b”, and a drain of N2 is connected to the negative end of the differential output pair (TXN).

According to the embodiment of the present invention, a calibration module 30 is connected to a driving circuit 33. In the driving circuit 33, number of the I/O units which are in operation (conducted) is determined by a calibration signal C. Details of operation of a first I/O unit U1 are illustrated below.

FIG. 5A is a schematic diagram illustrating an equivalent circuit of the first IO unit U1 when a voltage level of the positive control signal D+ is greater than that of the negative control signal D−. When the voltage level of the positive control signal D+ is greater than that of the negative control signal D−, the first P type transistor (P1) and the second N type transistor (N2) are turned off, and the second P type transistor (P2) and the first N type transistor (N1) are turned on. The second P type transistor (P2) is with a resistance of Rp2_u1, and the first N type transistor (N1) is with a resistance of Rn1_u1. Thus, in a case that the voltage level of the positive control signal D+ is greater than that of the negative control signal D−, an external current Iext_u1 flows from the node “a” to the node “b” via the second P type transistor (P2), the negative end of the differential output pair (TXN), the external resistor (Rext), the positive end of the differential output pair (TXP) and the first N type transistor (N1).

FIG. 5B is a schematic diagram illustrating an equivalent circuit of the first IO unit U1 when a voltage level of the positive control signal D+ is less than that of the negative control signal D−. When the voltage level of the positive control signal D+ is less than that of the negative control signal D−, the first P type transistor (P1) and the second N type transistor (N2) are turned on, and the second P type transistor (P2) and the first N type transistor (N1) are turned off. The first P type transistor (P1) is with a resistance of Rp1_u1, and the second N type transistor (N2) is with a resistance of Rn2_u1. Thus, in a case that the voltage level of the positive control signal D+ is less than that of the negative control signal D−, an external current Iext_u1 flows from the node “a” to the node “b” via the first P type transistor (P1), the positive end of the differential output pair (TXP), the external resistor (Rext), the negative end of the differential output pair (TXN) and the second N type transistor (N2).

Based on the illustrations of FIGS. 5A and 5B, controlling voltage difference between the positive control signal D+ and the negative control signal D− implies two distinguish logical levels generated at two ends of the external resistor (Rext).

When the calibration module 30 controls only the first IO unit U1 to be in operation according to the calibration signal C, a superimposed current flowing though the external resistor (Rext) is the external current Iext_u1. Similarly, when the calibration module 30 controls the first IO unit U1 and the third IO unit U3 to be in operation according to the calibration signal C, the superimposed current in this case is equivalent to summation of the external currents Iext_u1 and Iext_u3 (that is, superimposed current=Iext_u1+Iext_u3). In addition, when the calibration module 30 controls the first, the second and the third IO units U1, U2, U3 to be in operation, the superimposed current flowing through the external resistor (Rext) is equivalent to summation of the external currents Iext_u1, Iext_u2 and Iext_u3 (that is, superimposed current=Iext_u1+Iext_u2+Iext_u3). Certainly, in a case that the driving circuit 33 includes more IO units, more external currents can be summed together to retrieve the superimposed current flowing through the external resistor (Rext). That is, when number of the IO units in operation changes, current value of the superimposed current will change.

According to the above illustrations, the calibration module 30 utilizes the calibration signal C to adjust number of IO units to be in operation (conducted) so that the current flowing through the external resistance can be precisely adjusted to be +3 mA and −3 mA. Thus, the voltage difference of +300 mV and −300 mV can be accordingly generated at two ends of the external resistor (Rext).

In other words, the calibration module 30 in the present invention generates the calibration signal C, which is used to control resistance of the positive resistor (Rp) and the negative resistor (Rn). When resistances of the positive resistor (Rp) and the negative resistor (Rn) are adjusted to be 50 ohm, the current flowing through the external resistor (Rext) is either +3 mA or −3 mA. Consequentially, the voltage difference of +300 mV and −300 mV are generated at two ends of the external resistor (Rext).

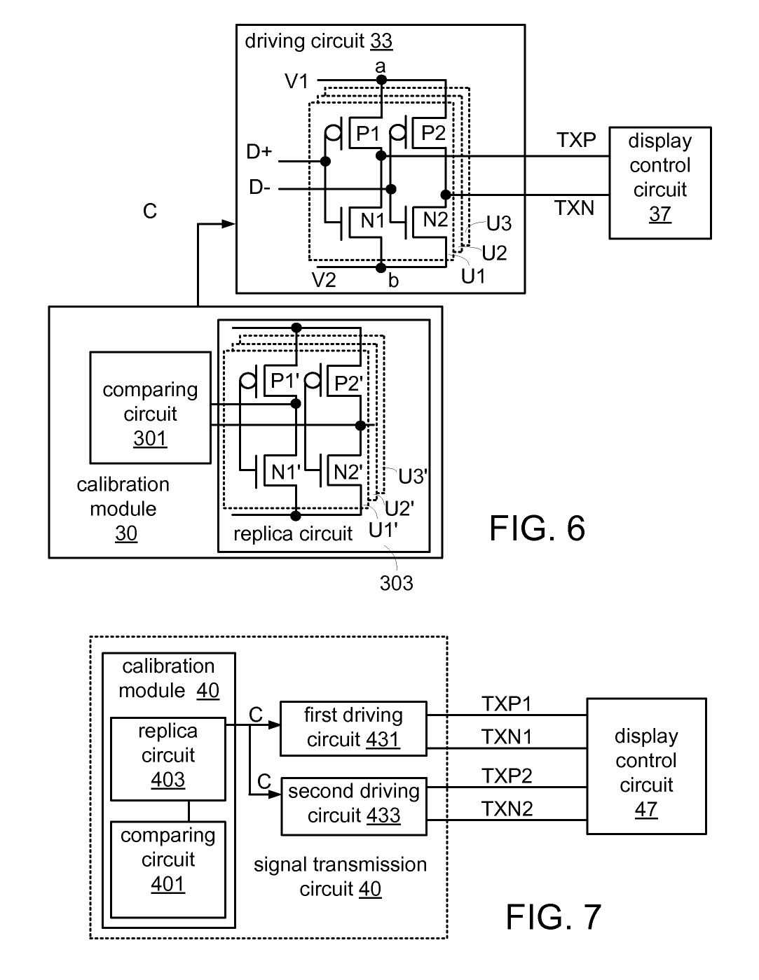

FIG. 6 is a schematic diagram illustrating the calibration signal is utilized by the calibration module to adjust IO unit in the driving circuit. The structure of the driving circuit 33 is similar to that of FIG. 4 and is not reluctantly described. Furthermore, the circuit shown in FIG. 6 is designed in the timing controller of the display system.

The calibration module 30 includes at least a replica circuit 303 and a comparing circuit 301. The replica circuit 303 is substantially identical to the driving circuit 33. The replica circuit 303 includes plural reference IO units U1′, U2′ U3′. The replica circuit 303 is a replica of the driving circuit 33, wherein the replica circuit 303 and the driving circuit 33 are manufactured under same fabrication condition.

When the calibration module 30 proceeds calibration, the comparing circuit 301 consistently changes the number of reference IO units U1′, U2′, U3′ in the replica circuit 303 which are in operation. When the comparing unit 301 confirms which reference IO units are in operation, the generated reference resistor will be compatible with the external resistor (Rext). After that, the calibration module 30 will notify the driving circuit 33 with the calibration signal C so that operation status of the IO units in the driving circuit 33 will be updated accordingly.

Implementation of the comparing circuit 301 and how the reference IO units in the replica circuit 303 are controlled by the comparing circuit 301 in order to generate the reference resistors are not limited.

According to the embodiment of the present invention, when the display system operates normally, the differential circuit in the driving circuit of the timing controller continuously generates image signals. The image signals are outputted to the display control circuit 37 via the differential output pair (TXP and TXN).

When the display system operates normally, the calibration module 30 calibrates driving capability of the replica circuit 303 and determines the reference resistor. For the display control interface, if the 10 circuits in the driving circuit 33 are adjusted when the timing controller is transmitting image signals, content of the image to be displayed may be affected. Thus, a blanking interval is utilized by the present invention to adjust the driving circuit 33.

When frame data are displayed, a vertical blanking interval (hereinafter, VBI) exists in the vertical synchronous signal (Vsync). When two continuous lines are horizontally scanned, a horizontal blanking interval exists between the horizontal synchronous signals (Hsync). The display does not display images during the vertical blanking interval and the horizontal blanking interval.

During the horizontal or the vertical blanking intervals, no effective image data will be generated to the display control circuit 37. Thus, adjusting the equivalent resistance of the differential circuit during the horizontal or the vertical blanking intervals does not affect quality of the image to be displayed.

When the synchronous signals in the image signals indicate the blanking intervals, the calibration module 30 may use the calibration signal C to determine how many of the IO units in the driving circuit being connected in parallel should be conducted. That is, the driving circuit according to the present invention adjusts the equivalent resistance of the IO units during the blanking intervals between the synchronous signals.

In practical applications, plural channels are often provided by the signal transmission circuit. Thus, the signal transmission circuit includes plural driving circuits. Similarly, the present invention can adjust the resistance settings of these driving circuits during idle intervals.

FIG. 7 is a schematic diagram illustrating multiple driving circuits output to the display control circuit. For the sake of convenience, the signal transmission circuit 40 is assumed to include a first driving circuit 431 and a second driving circuit 433.

In practical applications, the number of driving circuits included by the signal transmission circuit 40 is not limited. Each driving circuit individually includes plural IO units which are connected in parallel. Operations of the IO units are similar and are not described. Each of the driving circuits respectively corresponding to an external resistor. These driving circuits adjust the IO units to be in operation or not according to the calibration signal C transmitted from the calibration module 40. With conduction setting of the IO units, the positive resistor (Rp) and the negative resistor (Rn) are compatible with the external resistor.

The first driving circuit 431 is electronically connected to a first external resistor through the first differential output pair (TXP1, TXN1). Via the first differential output pair (TXP1, TXN1), the first driving current flows through the first external resistor. The second driving circuit 433 is electrically connected to a second external resistor via the second differential output pair (TXP2, TXN2). Furthermore, via the second differential output pair (TXP2, TXN2), the second driving current flows through the second external resistor. The calibration module 40 includes the comparing circuit 401 and the replica circuit 403. The replica circuit 403 is controlled by the comparing circuit 401. Firstly, conduction settings of the reference resistors are received. Then, the calibration signal C is outputted to the first driving circuit 431 and the second driving circuit 433.

When the signal transmission circuit according to the present invention is applied to a full HD TV with 120 Hz, the vertical blanking interval of such display system is greater than 50 us. Less than 5 us is required to calibrate all driving circuits for a signal transmission circuit according to an embodiment of the present invention.

In other words, less than one tenth of the vertical blanking interval is required to finish resistor setting of the signal transmission circuit. Thus, according to the present invention, the image to be displayed will not shake with changing of the resistors.

According to the above, a resistor setting method applied to the signal transmission circuit is provided in the present invention. The signal transmission circuit includes at least a driving circuit and the calibration module.

Among them, each driving circuit respectively includes plural IO units and a differential output pair electrically connected to the external resistor. On the other hand, the calibration module includes the comparing circuit and the replica circuit. The replica circuit includes plural reference IO units which have identical transistor layout as the IO units of the driving circuit.

While applying the present invention to the display, the operation of the IO units will be set during the blanking intervals of the image signals. Thus, the display effects of the display can be maintained. Similarly, based on same scenario of the present invention, proper blanking or idle intervals in different types of application can be utilized to set the IO units in the signal transmission circuit.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A signal transmission circuit comprising:
a first driving circuit, comprising
a first differential output pair, comprising a positive end and a negative end, electrically connected to a first external resistor; and
a plurality of input/output units, electrically between a first node and a second node, for receiving a positive control signal and a negative control signal, and generating a first superimposed current at the first differential output pair; and
a calibration module, electrically connected to the first driving circuit, for transmitting a calibration signal to the first driving circuit, for setting whether the input/output units in the first driving circuit are in operation, and generating the first superimposed current flowing to the first external resistor according to the positive control signal and the negative control signal.

2. The signal transmission circuit according to claim 1, wherein the calibration module transmits the calibration signal to the first driving circuit during a blanking interval.

3. The signal transmission circuit according to claim 2, wherein the blanking interval is a vertical blanking interval or a horizontal blanking interval of a display.

4. The signal transmission circuit according to claim 1, wherein a first input/output unit among the plurality of the input/output units comprises:
a first P type transistor, with a gate receiving the positive control signal, a source connected to the first node, and a drain connected to the positive end of the first differential output pair;
a first N type transistor, with a gate receiving the positive control signal, a drain connected to the positive end of the first differential output pair, and a source connected to the second node;
a second P type transistor, with a gate receiving the negative control signal, a source connected to the first node, and a drain connected to the negative end of the first differential output pair; and
a second N type transistor, with a gate receiving the negative control signal, a drain connected to the negative end of the first differential output pair and a source connected to the second node.

5. The signal transmission circuit according to claim 1, wherein the calibration module comprises:
a replica circuit, comprising a plurality of reference input/output units which are connected in parallel, and the plurality of reference input/output units are identical to the plurality of output/input units in the first driving circuit; and
a comparing circuit, electrically connected to the replica circuit, for determining a reference resistor by adjusting operation of the plurality of reference input/output units, and generating the calibration signal to the first driving circuit.

6. The signal transmission circuit according to claim 5, further comprising:
a second driving circuit, comprising:
a second differential output pair, electrically connected to a second external resistor; and
a plurality of input/output units, electrically connected between a third node and a fourth node, wherein the plurality of reference input/output units are identical to the plurality of input/output units in the second driving circuit, and whether the input/output units in the second driving circuit are in operation is set according to the calibration signal, wherein the plurality of input/output units in the second driving circuit generates a second superimposed current flowing to the second external resistor.
